(19) United States
(12) Patent Application Publication
(10) Pub. No.: US 2026/0367005 A1
(43) Pub. Date: Nov. 19, 2026

(54) CHIP-INTEGRATED NANOLAMINATE NANO-OPTOELECTRODE ARRAYS FOR INTERFACIAL ELECTROCHEMICAL REACTION MONITORING

(71) Applicant: VIRGINIA TECH INTELLECTUAL PROPERTIES, INC., Blacksburg, VA (US)

(72) Inventors: Yuming Zhao, Blacksburg, VA (US); Chuan Xiao, Blacksburg, VA (US); Wei Zhou, Blacksburg, VA (US)

(21) Appl. No.: 19/515,269

(22) PCT Filed: Jul. 1, 2024
(86) PCT No.: PCT/US2024/036390

§ 371 Date: Feb. 27, 2026

Related U.S. Application Data
(60) Provisional application No. 63/580,136, filed on Sep. 1, 2023.

(51) Int. Cl. G01N 21/65

(52) U.S. Cl. CPC G01N 21/658

(57) ABSTRACT

Embodiments of a nanolaminate nano-optoelectrode (NLNOE) device and method for operating the same are described. In one example, a nano-optoelectrode device includes a substrate and a conductive layer coupled to the substrate. The nano-optoelectrode device further includes a nano-optoelectrode coupled to the conductive layer. The nano-optoelectrode includes a conductive nanopillar extending from the conductive layer. The nano-optoelectrode further includes a nanostructure coupled to the conductive nanopillar. The nanostructure includes alternating layers of reactive metal and stable plasmonic metal. The nano-optoelectrode further includes a plasmonic nanocavity hotspot on a side of the nanostructure. The plasmonic nanocavity hotspot includes side surfaces of the alternating layers of reactive metal and stable plasmonic metal of the nanostructure.

### CROSS REFERENCE TO RELATED APPLICATIONS

This application claims the benefit of and priority to U.S. Provisional Application Ser. No. 63/580,136, filed Sep. 1, 2023, titled “CHIP-INTEGRATED NANOLAMINATE NANO-OPTOELECTRODE ARRAYS FOR INTERFACIAL ELECTROCHEMICAL REACTION MONITORING,” the entire contents of which are hereby incorporated herein by reference.

### STATEMENT REGARDING FEDERALLY SPONSORED RESEARCH OR DEVELOPMENT

This invention was made with government support under grant number FA9550-18-1-0328, awarded by the Air Force Office of Scientific Research (AFOSR). The government has certain rights in the invention.

### BACKGROUND

Understanding transition states (TSs)—the highest-energy configurations in a reaction pathway—is crucial for unraveling reaction mechanisms, controlling rates, and developing efficient catalysts. Advances in spectroscopic techniques and computational models have facilitated the investigation of TSs, known for their short lifetimes. Interfacial electrochemical reactions at the solid electrode-liquid electrolyte boundary are pivotal in catalysis, biosensing, and energy conversion. Unlike bulk reactions, interfacial electrochemical reactions occur in nanometer-thin layers, necessitating highly sensitive detection methods. A significant challenge is background interference from bulk electrolytes and electrodes, often obscuring weak signals from the interfacial region and traditional spectroelectrochemistry struggles to discern these short-lived TSs due to such noise.

### SUMMARY

The present disclosure is directed to embodiments of a nanolaminate nano-optoelectrode (NLNOE) device and methodology for operating the same. The NLNOE device includes an array of nano-optoelectrodes extending from a conductive layer formed on a substrate. Each of the nano-optoelectrodes includes a conductive nanopillar extending from the conductive layer, a multi-layered optical nanostructure coupled to the conductive nanopillar, and a plasmonic nanocavity hotspot on a side of the multi-layered optical nanostructure. The multi-layered optical nanostructure includes alternating layers of reactive metal and stable plasmonic metal. The plasmonic nanocavity hotspot includes side surfaces of the alternating layers of reactive material and stable plasmonic metal. The alternating layers of reactive metal and stable plasmonic metal can be embodied as alternating layers of silver (Ag) and gold (Au) in one example, although other metals may be used for particular applications. The NLNOE method includes a dual-channel in situ EC-SERS process that blends plasmon-enhanced vibrational (PE-VRS) and electronic Raman scattering (PE-ERS) using the NLNOE device for real-time monitoring of TSs in electrochemical redox reactions within plasmonic nanocavities.

Aspects and advantages of embodiments of the present disclosure will be set forth in part in the following description or can be learned from the description or through practice of the embodiments. Other aspects and advantages of embodiments of the present disclosure will become better understood with reference to the appended claims and the accompanying drawings, all of which are incorporated in and constitute a part of this specification. The drawings illustrate example embodiments of the present disclosure and, together with the description, serve to explain the related concepts of the present disclosure.

According to one example embodiment, a nano-optoelectrode device includes a substrate and a conductive layer coupled to the substrate. The nano-optoelectrode device further includes a nano-optoelectrode coupled to the conductive layer. The nano-optoelectrode includes a conductive nanopillar extending from the conductive layer. The nano-optoelectrode further includes a nanostructure coupled to the conductive nanopillar. The nanostructure includes alternating layers of reactive material and stable plasmonic metal. The nano-optoelectrode further includes a plasmonic nanocavity hotspot on a side of the nanostructure. The plasmonic nanocavity hotspot includes side surfaces of the alternating layers of reactive metal and stable plasmonic metal of the nanostructure.

According to another example embodiment, a nano-optoelectrode system includes a potentiostat, a continuous wave laser, and a nano-optoelectrode device coupled to the potentiostat and the continuous wave laser. The nano-optoelectrode device includes a substrate and a conductive layer coupled to the substrate. The nano-optoelectrode device further includes a nano-optoelectrode coupled to the conductive layer. The nano-optoelectrode includes a conductive nanopillar extending from the conductive layer. The nano-optoelectrode further includes a nanostructure coupled to the conductive nanopillar. The nanostructure includes alternating layers of reactive metal and stable plasmonic metal. The nano-optoelectrode further includes a plasmonic nanocavity hotspot on a side of the nanostructure. The plasmonic nanocavity hotspot includes side surfaces of the alternating layers of reactive metal and stable plasmonic metal of the nanostructure.

### BRIEF DESCRIPTION OF THE DRAWINGS

Many aspects of the present disclosure can be better understood with reference to the following figures. The components in the figures are not necessarily to scale, with emphasis instead being placed upon clearly illustrating the concepts of the disclosure. Moreover, repeated use of reference characters or numerals in the figures is intended to represent the same or analogous features, elements, or operations across different figures. Repeated description of such repeated reference characters or numerals is omitted for brevity.

FIG. 1A illustrates a cross-sectional side-view of an example nanolaminate nano-optoelectrode (NLNOE) array device according to various aspects and embodiments of the present disclosure.

FIG. 1B illustrates a top view of an example nanolaminate nano-optoelectrode (NLNOE) of the example NLNOE array device of FIG. 1A according to various aspects and embodiments of the present disclosure.

FIG. 1C illustrates a cross-sectional side-view of the example NLNOE of FIG. 1B according to various aspects and embodiments of the present disclosure.

FIG. 2A illustrates a diagram of an example implementation of the example NLNOE array device of FIG. 1A according to various aspects and embodiments of the present disclosure.

FIG. 2B illustrates a diagram of an example nanolaminate nano-optoelectrode (NLNOE) system and example implementation thereof according to various aspects and embodiments of the present disclosure.

FIG. 3 illustrates a flow diagram of an example fabrication method according to various aspects and embodiments of the present disclosure.

### DETAILED DESCRIPTION

Understanding transition states (TSs) is critical for reaction optimization and catalyst development. Interfacial electrochemical reactions at the solid electrode-liquid electrolyte boundary are particularly pivotal in catalysis, biosensing, and energy conversion. However, unlike bulk reactions, interfacial electrochemical reactions occur in nanometer-thin layers, necessitating highly sensitive detection methods. A significant challenge with investigating such interfacial electrochemical reactions is background interference from bulk electrolytes and electrodes often obscures weak signals from the interfacial region and traditional spectroelectrochemistry struggles to discern these short-lived TSs due to such noise.

Surface plasmons have become a promising solution for enhancing the sensitivity of spectroelectrochemical techniques. Surface plasmons are collective oscillations of metal's free electrons at the metal-dielectric interface, which can focus and intensify optical fields at the nanoscale, boosting diverse nonlinear emission signals, including fluorescence, Raman scattering, and harmonic generation. By utilizing surface plasmons, spectroelectrochemistry techniques have shown promise in detecting interfacial activities with high sensitivity. Notably, combining plasmonic enhancement with ultrafast spectroscopy has emerged as an essential development, allowing for time-resolved studies of interfacial chemical processes. However, a notable limitation exists: current pump-probe methods rely primarily on pulsed optical pumping, which is unsuitable for tracking fast interfacial events during electrochemical reactions that require pulsed electrical pumping.

On a parallel track, electrochemical surface-enhanced Raman spectroscopy (EC-SERS) has emerged as a robust technique for monitoring electrochemical activities, including those semi-stable intermediate states, but its effectiveness in capturing TSs remains elusive. Furthermore, understanding the dependence of plasmon-enhanced metal luminescence behaviors under electrode voltage modulation is not yet comprehensive. Additionally, prior EC-SERS studies often employ non-uniform devices with randomly distributed and mechanically unstable plasmonic hotspots, compromising measurement reliability. Finally, traditional Raman and SERS measurements can only examine vibrational information of chemical bonds and are therefore incapable of probing the changes of interfacial electronic states during reactions.

Embodiments described herein include a nanolaminate nano-optoelectrode (NLNOE) device and method for operating the same. The NLNOE method includes implementing the NLNOE device to perform a dual-channel in situ EC-SERS methodology that harnesses the synergy between plasmon-enhanced vibrational Raman scattering (PE-VRS) and plasmon-enhanced electronic Raman scattering (PE-ERS) interfacial signals to monitor TSs of electrochemical redox reactions in real-time or near real-time within plasmonic nanocavities. The NLNOE device includes an array of nano-optoelectrodes extending from a conductive layer formed on a substrate. Each of the nano-optoelectrodes includes a conductive nanopillar extending from the conductive layer, a multi-layered optical nanostructure coupled to the conductive nanopillar, and a plasmonic nanocavity hotspot on a side of the multi-layered optical nanostructure. The multi-layered optical nanostructure includes alternating layers of reactive metal and stable plasmonic metal. The plasmonic nanocavity hotspot includes side surfaces of the alternating layers of reactive metal and stable plasmonic metal.

One embodiment of the NLNOE device includes a gold (Au)-silver (Ag) nanolaminate nano-optoelectrode (NLNOE) that can be used to implement the NLNOE dual-channel in situ EC-SERS methodology. The Au/Ag NLNOE device includes electrically connected, spatially uniform, optically dense, and mechanically robust plasmonic hotspots in one example, which enable EC-SERS measurements to capture correlated vibrational and electronic signatures of the silver (Ag)-chlorine (Cl) (AgCl)*TS in a AgCl(s)+e⁻ [symbol] Ag(s)+Cl⁻(aq) redox reaction. An intuitive microscopic model was applied in one example implementation of the NLNOE device and method to illuminate the quasi-reversible nature of this redox process and elucidate the pivotal role of the TS in modulating PE-ERS and PE-VRS signals from plasmonic nanocavities.

A significant increase in the PE-ERS signal intensity was observed in one example implementation of the NLNOE device and method during the redox reaction when the (AgCl)*TS emerged, which may be attributed to the weak hybridization of Ag sp bands with Cl atomic orbitals, resulting in a quasi-continuous electronic band structure to produce extra ERS signals. Such an observation contrasts the behavior of the covalent Ag—Cl bond, whose large energy gap inhibits the generation of PE-ERS signals. Simultaneously, the (AgCl)*TS in this example exhibited partial bonding with an increased ability for electron cloud distortion to increase its polarizability changes relative to the steady-state polar covalent Ag—Cl bond, leading to an elevated Raman scattering cross-section, thereby increasing the PE-VRS signals during the redox reaction. Additionally, an intriguing temporal misalignment was observed in one example implementation of the NLNOE device and method. The temporal misalignment was between electrochemical current intensity and PE-ERS/PE-VRS emission intensity peaks, a phenomenon that may be ascribed to the location-dependent modification of plasmonic field enhancement factors within the porous Ag/AgCl networks as the redox reaction occurs. The NLNOE device and methodology, as well as findings observed from example implementations thereof, pave the way for a cutting-edge platform with transformative potential in advancing our understanding of TSs in interfacial electrochemical reactions, thereby holding immense promise for interfacial science, electrochemistry, and analytical chemistry.

The NLNOE device and methodology allow for embedding the reaction spots in the dense plasmonic hotspots, facilitating direct monitoring and analysis of the target electrochemical reaction by way of electronic and vibrational Raman dual signal channels. In one specific example, the NLNOE device and methodology allow for capturing the vibrational footprints of surface and molecular bonding and also provide the electrode surface electronic information during a Faradaic process. The NLNOE device and methodology allow for new visions in areas such as catalysis, biosensing and energy conversion.

Other embodiments described herein include a modular design approach and a scalable fabrication process for constructing the NLNOE device. The NLNOE device includes out-of-plane metallic multilayer nanoantennas with a conductive nanopillar substrate made of multi-walled carbon nanotubes (MWCNT) doped polyurethane (PU) in various examples. The NLNOE device has good electrochemical conductivity. By leveraging two-tier plasmonic modes hybridization, the NLNOE device owns strong near fields enhancements in visible-near infrared wavelength range. In one embodiment of the NLNOE device a metallic layer of silver (Ag) is inserted inside at least one out-of-plane metallic multilayer nanoantenna, which allows for the interfacial electrochemical reactions to be monitored through dual-channel electrochemical modulated plasmonic enhanced vibrational and electronic Raman scattering signals.

The NLNOE device and methodology have broad applications in electrochemical-related fields such as solar energy conversion, heterogeneous catalysis, and biosensing. Example potential commercial applications for the NLNOE device and methodology are extensive and include, but are not limited to, monitoring and analyzing an interfacial electrochemical process, improvement of electrocatalysis and solar energy conversion, and detecting biomolecules such as deoxyribonucleic acid (DNA) and proteins under electrochemical modulation. Overall, the NLNOE device and methodology offer a versatile and powerful tool for researchers and companies working in electrophysiology and related fields.

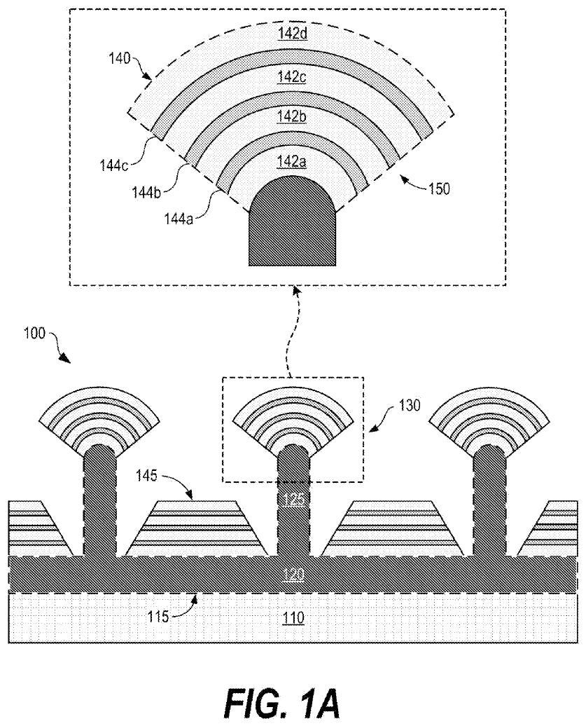

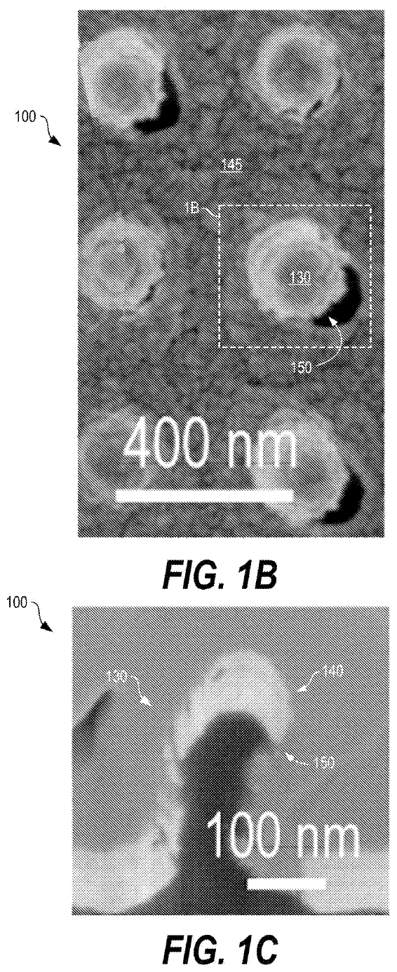

Turning now to the figures, FIGS. 1A to 1C illustrate different views of an example nanolaminate nano-optoelectrode (NLNOE) array device 100 (or “NLNOE array device 100”) according to various aspects and embodiments of the present disclosure. FIG. 1A illustrates a cross-sectional side-view of the example NLNOE array device 100 according to various aspects and embodiments of the present disclosure. FIG. 1B illustrates a top view of an example nanolaminate nano-optoelectrode (NLNOE) 130 of the NLNOE array device 100 of FIG. 1A according to various aspects and embodiments of the present disclosure. A bounding box 1B depicted in FIG. 1B includes the NLNOE 130 formed on the NLNOE array device 100. FIG. 1C illustrates a cross-sectional side-view of the NLNOE 130 included in the bounding box 1B of FIG. 1B.

The NLNOE array device 100 can be embodied as a NLNOE probe device that can be implemented to probe transition states of redox reactions as described in some examples herein. The NLNOE array device 100 can be embodied as a NLNOE probe device that can be implemented to capture in situ electrochemical surface-enhanced Raman spectroscopy measurements as described in other examples. The NLNOE array device 100 can be embodied as a NLNOE probe device that can be implemented to capture vibrational and electronic signatures of silver-chlorine transition states in a redox reaction based at least in part on plasmon-enhanced vibrational Raman scattering and plasmon-enhanced electronic Raman scattering, respectively, as described in still other examples.

Referring amongst FIGS. 1A to 1C, the NLNOE array device 100 includes a substrate 110. The substrate 110 can be embodied as any structure on which integrated circuits, such as one or more NLNOEs, can be formed and that is capable of supporting such circuits. The substrate 110 can be embodied as and/or include at least one of a polymer material or composite, a metal material or alloy, a glass material or composite, a fiberglass material, a rigid or flexible circuit board (e.g., a rigid or flexible printed circuit board), a silicon (Si) material or wafer, or another type of material or substrate. The substrate 110 can be embodied as a polyethylene terephthalate (PET) substrate in one example.

The NLNOE array device 100 also includes a conductive nanopillar array structure 115 formed on and coupled to the substrate 110. The conductive nanopillar array structure 115 is formed as and includes a conductive layer 120 coupled to the substrate 110 and an array of conductive nanopillars 125 extending from the conductive layer 120. Only a single conductive nanopillar 125 is denoted in one or more of FIGS. 1A to 1C for clarity. The conductive nanopillar array structure 115 (e.g., the conductive layer 120 and the conductive nanopillars 125) can be embodied as and/or formed from and include a multiwall carbon nanotube doped polyurethane compound in one example, although other materials may be used in some cases.

The NLNOE array device 100 further includes nanolaminate nanoantennas (NLNAs) 140 respectively coupled to distal ends of the conductive nanopillars 125. Only a single NLNA 140 is denoted in one or more of FIGS. 1A to 1C for clarity. Each coupled NLNA 140 and conductive nanopillar 125 forms a nanolaminate nano-optoelectrode (NLNOE) 130 extending from the conductive layer 120. Individually coupled NLNAs 140 and conductive nanopillars 125 collectively form an array of NLNOEs 130 extending from the conductive layer 120. Only a single NLNOE 130 is denoted in one or more of FIGS. 1A to 1C for clarity. The NLNOEs 130 are formed on the NLNOE array device 100 according to a certain pattern (e.g., a periodic pattern) in the example shown. However, in some cases, the NLNOEs 130 may be formed on the NLNOE array device 100 according to a pattern that is different from that shown in FIGS. 1A and 1B. In other examples, a first subset of the NLNOEs 130 may be formed on the NLNOE array device 100 in a first defined pattern and a second subset of the NLNOEs 130 may be formed on the NLNOE array device 100 in a second defined pattern.

The NLNA 140 of each of the NLNOEs 130 is embodied as and includes a multilayered stable plasmonic metal-reactive metal-stable plasmonic metal nanostructure. The NLNA 140 is embodied as and includes at least one of a nanoantenna, an optical nanoantenna, or a nanocavity. The NLNA 140 is formed as a stack of alternating nanoscale films or layers of a stable plasmonic metal and a reactive metal deposited on distal ends of the conductive nanopillar 125 as described herein and illustrated in FIGS. 1A and 1C. Portions of such alternating nanoscale films or layers of a stable plasmonic metal and a reactive metal are also formed as a multilayered nanostructure 145 on a top surface of the conductive layer 120 as described herein and illustrated in FIGS. 1A and 1C.

The NLNA 140 of each of the NLNOEs 130 includes one or more stable plasmonic metal films or layers 142a, 142b, 142c, 142d (or “stable plasmonic metal layers 142”) and one or more reactive metal films or layers 144a, 144b, 144c (or “reactive layers 144”) deposited between the stable plasmonic metal layers 142 as illustrated in FIGS. 1A and 1C. The stable plasmonic metal layer 142a is formed on a distal end of the conductive nanopillar 125 in the example shown. The reactive metal layer 144a is formed on the stable plasmonic metal layer 142a. The stable plasmonic metal layer 142b is formed on the reactive metal layer 144a. The reactive metal layer 144b is formed on the stable plasmonic metal layer 142b. The stable plasmonic metal layer 142c is formed on the reactive metal layer 144b. The reactive metal layer 144c is formed on the stable plasmonic metal layer 142c. The stable plasmonic metal layer 142d is formed on the reactive metal layer 144c.

Each of the stable plasmonic metal layers 142 can be embodied as and include a stable plasmonic metal. Any or all of the stable plasmonic metal layers 142 can be embodied as a gold (Au) layer in one example. Any or all of the stable plasmonic metal layers 142 can be embodied as a titanium nitride (TiN) layer in another example. Each of the reactive metal layers 144 can be embodied as and include a reactive metal. Any or all of the reactive metal layers 144 can be embodied as a silver (Ag) layer in one example. Any or all of the reactive metal layers 144 can be embodied as a rare earth metal layer in another example. For instance, any or all of the reactive metal layers 144 can be embodied as one or more of a scandium (Sc) layer, a yttrium (Y) layer, a lanthanum (La) layer, a cerium (Ce) layer, a praseodymium (Pr) layer, a neodymium (Nd) layer, a promethium (Pm) layer, a samarium (Sm) layer, a europium (Eu) layer, a gadolinium (Gd) layer, a terbium (Tb) layer, a dysprosium (Dy) layer, a holmium (Ho) layer, an erbium (Er) layer, a thulium (Tm) layer, a ytterbium (Yb) layer, or a lutetium (Lu) layer. Each of the stable plasmonic metal layers 142 is embodied as a gold (Au) layer and each of the reactive metal layers 144 is embodied as a silver (Ag) layer in one example.

The thickness of each of the stable plasmonic metal layers 142 and the reactive metal layers 144 may be the same in some cases. In other examples, at least one of the stable plasmonic metal layers 142 or the reactive metal layers 144 may have a thickness that is different from that of at least one other layer of the stable plasmonic metal layers 142 or the reactive metal layers 144. Any or all of the stable plasmonic metal layers 142 can have a thickness that is approximately equal to or greater than 20 nanometers (nm) and less than or approximately equal to 25 nm in various examples. Any or all of the reactive metal layers 144 can have a thickness that is approximately equal to or greater than 5 nm and less than or approximately equal to 15 nm in various examples. At least one of the reactive metal layers 144 has a thickness that is approximately equal to or greater than 5 nm and less than or approximately equal to 10 nm in one example. At least one of the reactive metal layers 144 has a thickness that is approximately equal to or greater than 7.5 nm and less than or approximately equal to 12.5 nm in another example. At least one of the reactive metal layers 144 have a thickness that is approximately equal to or greater than 10 nm and less than or approximately equal to 15 nm in still another example. The reactive metal layers 144a, 144b, 144c have respective thicknesses of approximately 8 nm, 10 nm, and 12 nm in yet another example. Each of the stable plasmonic metal layers 142 is embodied as a nanoscale layer of gold (Au) and each of the reactive metal layers 144 is embodied as a nanoscale layer of silver (Ag) in one example.

The NLNA 140 of each of the NLNOEs 130 further includes one or more plasmonic nanocavity hotspots 150 (or “hotspots 150”) on a side of the NLNA 140. Only a single hotspot 150 is denoted in FIGS. 1A to 1C for clarity. The hotspots 150 include plasmonic nanocavities formed on and into a side surface of the NLNA 140. Any or all of such plasmonic nanocavities can individually or collectively form one or more of the plasmonic nanocavity hotspots 150. The hotspots 150 are embodied and implemented as stable plasmonic metal-reactive metal-stable plasmonic metal nanocavity hotspots. The hotspots 150 can be embodied and implemented as plasmonic Au—Ag—Au nanocavity hotspots in one example.

The stable plasmonic metal layers 142 and the reactive metal layers 144 can be deposited on the conductive nanopillar array structure 115 (e.g., the conductive layer 120 and the conductive nanopillars 125) by way of electron-beam evaporation of each of such layers. One or more side surfaces of any or all of the stable plasmonic metal layers 142 and the reactive metal layers 144 can then be exposed to an approximate 1-minute wet etching using a chromium (Cr) etchant to form the aforementioned plasmonic nanocavities on and into a side surface of the NLNA 140. Such wet etching creates and then exposes the plasmonic nanocavities to a surrounding environment or medium for fluid penetration (e.g., electrolyte penetration) during operation and increases sidewall roughness.

Each hotspot 150 is formed or defined as and thus includes an exposed side portion or surface of a NLNA 140. Each hotspot 150 is formed or defined as and thus includes exposed side portions (e.g., exposed side surfaces) of the stable plasmonic metal layers 142 and the reactive metal layers 144. Some hotspots 150 can be formed or defined as and thus include exposed side surfaces of the stable plasmonic metal layers 142b, 142c and the reactive metal layer 144b in one example. Some hotspots 150 can be at least partly formed or defined as and thus include exposed side surfaces of at least one of the reactive metal layers 144a, 144b, 144c in another example. The exposed side surfaces of the stable plasmonic metal layers 142 and the reactive metal layers 144 forming each hotspot 150 are designed and fabricated such that they are not coated and thus can be exposed to various physiological ionic solutions (e.g., electrolytes) when the NLNOE array device 100 is implemented. During implementation of the NLNOE array device 100, the conductive nanopillar array structure 115 (e.g., the conductive layer 120 and the conductive nanopillars 125), the NLNAs 140, and the hotspots 150 allow for nonlinear optical voltage sensing in various physiological ionic solutions (e.g., electrolytes) as described in examples herein.

Each of the NLNOEs 130 in the example shown is formed by and thus includes a conductive nanopillar 125, an NLNA 140, and a hotspot 150. The NLNOEs 130 (e.g., their respective conductive nanopillars 125, NLNAs 140, and hotspots 150) are electrically and optically coupled to one another, the conductive layer 120, and the substrate 110 in some cases. For instance, the substrate 110 and the conductive layer 120 together can form a conductive substrate in some examples. The substrate 110 and the conductive layer 120 together can form an electrically and optically conductive substrate that is electrically and optically coupled to the conductive nanopillar 125, the NLNA 140, and the hotspot 150 of each of the NLNOEs 130 as described herein and illustrated in FIGS. 1A to 1C.

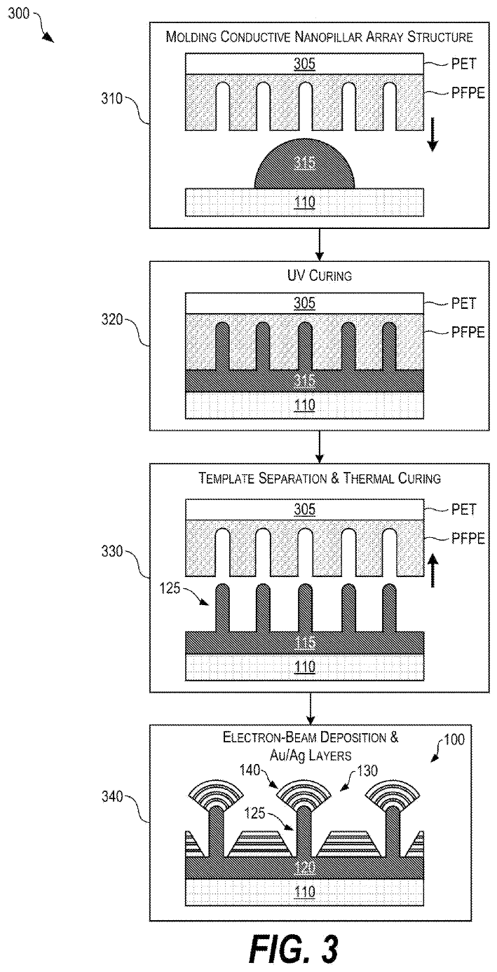

The design of the NLNOEs 130 such as the shape, materials used, and material arrangement, among other aspects, may vary depending on a particular bio-interfacing application or to achieve a desired result from a particular bio-interfacing operation. The NLNOE array device 100 and/or any of the components thereof, such as the NLNOEs 130, can be fabricated according to method 300 described herein with reference to FIG. 3. The method 300 provides a modular design approach and fabrication process for fabricating nanolaminate nano-optoelectrodes on a conductive substrate to form one or more of the nanolaminate nano-optoelectrode array devices described in examples herein.

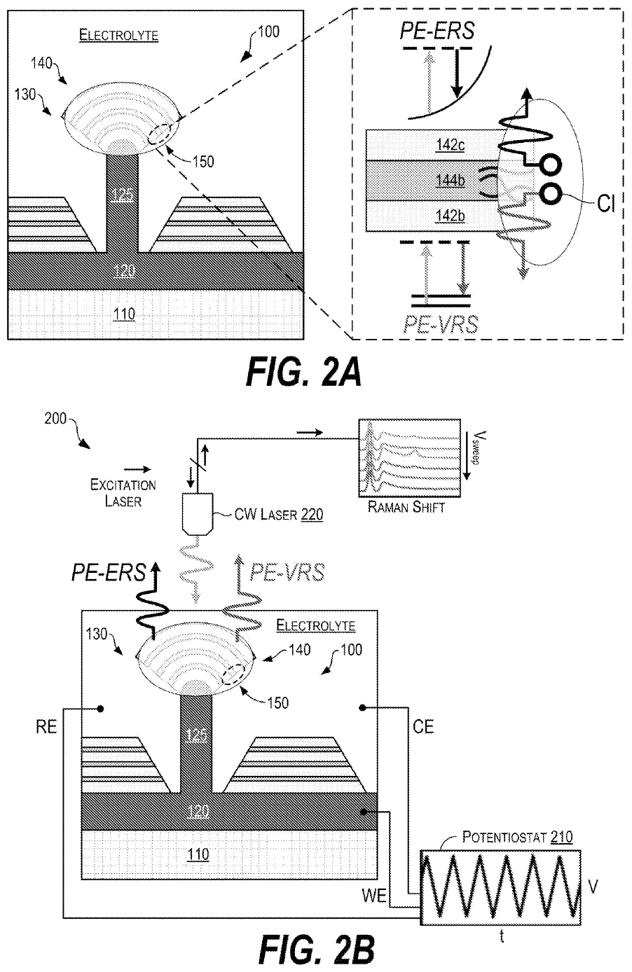

FIG. 2A illustrates a diagram of an example implementation of the NLNOE array device 100 according to various aspects and embodiments of the present disclosure. FIG. 2A further illustrates a diagram of example plasmon-enhanced electronic Raman scattering (PE-ERS) and plasmon-enhanced vibrational Raman scattering (PE-VRS) in hotspots 150 of an NLNOE 130 according to various aspects and embodiments of the present disclosure.

FIG. 2B illustrates a diagram of an example NLNOE system 200 and implementation thereof according to various aspects and embodiments of the present disclosure. FIG. 2B further illustrates a diagram of example in situ electrochemical surface-enhanced Raman spectroscopy (EC-SERS) measurements being obtained according to one embodiment by employing the NLNOE array device 100 during cyclic voltammetry (CV). The NLNOE system 200 includes a potentiostat 210, a continuous wave (CW) laser 220, and the NLNOE array device 100 coupled (e.g., electrically, mechanically, optically) to each of the potentiostat 210 and the continuous wave laser 220. The continuous wave laser 220 can be embodied and implemented as a 785 nm continuous wave laser in various examples. The conductive nanopillar array structure 115 (e.g., the conductive layer 120 and the conductive nanopillars 125) of the NLNOE array device 100 is embodied and implemented as a working electrode (WE) that is coupled to the potentiostat 210 by way of a copper wire in the example shown. The NLNA 140 is embodied and implemented as a reference electrode (RE) that is coupled to the potentiostat 210 in this example, and the NLNOE array device 100 is coupled to the potentiostat 210 by way of a platinum wire that is embodied and implemented as a counter electrode (CE).

Recent studies have revealed that PE-ERS primarily accounts for the low-wavenumber background in SERS measurements from noble metal nanocavity hotspots under continuous-wave (CW) laser excitation at near-infrared (NIR) wavelengths, as the interband transitions do not occur by low photon energy, and intraband transitions are unlikely due to momentum mismatch from sp-band dispersion. PE-ERS in metal originates from the electron-hole pair transitions near the Fermi energy E_{F}, with intensity proportional to

$${n}_{e - h} ( Δ ω ) ∝ n ( {E}_{F} ) {\vert exp ( - \frac{ℏ Δ ω}{{k}_{B} T} ) - 1 \vert}^{- 1} ,$$

where n(E_{F}) denotes the free electron density and

$${\vert exp ( - \frac{ℏΔω}{{k}_{B} T} ) - 1 \vert}^{- 1}$$

is the Bose-Einstein distribution of the electron-hole pairs at Raman-shift frequency Δω. Utilizing a long-pass filter to eliminate elastic laser scattering, a PE-ERS pseudo peak in the spectra was obtained in one example. In contrast to the continuous nature of PE-ERS signals, PE-VRS signals exhibit discrete peaks due to inelastic scattering involving distinct molecular vibrational modes. Both ERS and VRS signals undergo enhancement by a factor of |E_{SP}|⁴/|E₀|⁴ in plasmonic nanocavity hotspots, where E_{SP} is the local plasmonic electrical field and E₀ is the electrical field of incident excitation light. During in situ EC-SERS measurements PE-ERS and PE-VRS signals, originating from electronic states and molecular vibrational bonds at electrode-electrolyte interfaces, respectively, within the plasmonic hotspots can provide complementary insights into interfacial electrochemical activities during redox reactions.

Returning to FIGS. 2A and 2B, the NLNOE system 200 and the NLNOE array device 100 thereof can support an electrical dipole (ED) plasmon mode, concentrating enhanced electric fields at nanocavities' upper edges and consequently facilitating the generation of PE-ERS and PE-VRS signals with a shared plasmonic enhancement factor (EF). Through electric potential modulation using the potentiostat 210, the NLNOEs 130 can facilitate comprehensive EC-SERS spectral data collection, encompassing PE-ERS and PE-VRS signals. The conductive nanopillar array structure 115 (e.g., the conductive layer 120 and the conductive nanopillars 125) functions as the working electrode (WE) in this example of the in situ EC-SERS setup described herein, connected to the potentiostat 210 by way of a copper wire, while a saturated Ag/AgCl electrode (e.g., depicted in the inset of FIG. 2A) and a platinum wire act as the reference (RE) and counter electrodes (CE), respectively. Combined with a 785 nm CW laser 220 in this example, the configuration of the NLNOE system 200 allows for multiple cyclic voltammetry (CV) runs and capture of an inclusive EC-SERS spectrum using the NLNOE array device 100.

Efficient signal collection demands hotspots with electrochemical activity, electrical connection, and high EFs. Various embodiments of the NLNOE array device 100 can achieve such efficient signal collection. Embodiments of the NLNOE array device 100 as a two-tier Au—Ag NLNOE device with the NLNA 140 including alternating gold and silver layers can achieve such efficient signal collection by providing hotspots with electrochemical activity, electrical connection, and high EFs.

FIG. 3 illustrates a flow diagram of an example fabrication method 300 (or “method 300”) according to various aspects and embodiments of the present disclosure. The method 300 can be implemented to fabricate the NLNOE array device 100 described herein and illustrated in FIGS. 1A to 2B. The method 300 is a scalable nanoimprinting fabrication process and it can be implemented to produce wafer-scale NLNOE substrates that include one or more NLNOE array devices 100 that are each suitable for in situ EC-SERS measurements. The method 300 includes example operations or processing steps performed in a particular order for purposes of illustration and discussion. Those of ordinary skill in the art, using the disclosures provided herein, will understand that various operations or processing steps of the method 300 or any of the other methods disclosed herein may be adapted, modified, rearranged, performed simultaneously, include operations or processing steps not illustrated, and/or altered in various ways without deviating from the scope of the present disclosure.

At 310, the method 300 includes molding or nanoimprinting a carbon doped polyurethane (PU) compound into a conductive nanopillar array structure such as the conductive nanopillar array structure 115. At 310 a multiwall carbon nanotube (MWCNT) doped NOA83H polyurethane (PU) compound 315 can be molded into the conductive nanopillar array structure 115 using a reusable inverse perfluoropolyether (PFPE) nanohole array template 305. The PFPE nanohole array template 305 includes a PFPE nanohole array formed on a polyethylene terephthalate (PET) substrate. The PFPE nanohole array template 305 can be derived from a silicon master of square pillar arrays by way of nanoimprint lithography in one example. The PFPE nanohole array template 305 has relatively low surface energy and high Young's modulus which makes it ideal for molding a MWCNT (e.g., a mass fraction of 20%) doped NOA83H polyurethane (PU) compound into a conductive MWCNT/NOA83H nanopillar array on a silicon (Si) substrate, a PET substrate, or another substrate.

At 320, the method 300 includes ultraviolet (UV) curing. After molding or nanoimprinting the MWCNT doped PU compound 315 into the shape of the conductive nanopillar array structure 115 at 310, the method 300 further includes curing the MWCNT doped PU compound 315 using UV light to form the conductive nanopillar array structure 115.

At 330, the method 300 includes separating the PFPE nanohole array template 305 from the conductive nanopillar array structure 115 and thermally curing the conductive nanopillar array structure 115.

At 340, the method 300 includes depositing alternating layers of a reactive metal and a stable plasmonic metal on the conductive nanopillar array structure 115 formed at 330. Alternating films of Au (e.g., 25 nm thick) and Ag (e.g., 8 nm, 10 nm, and 12 nm thick) can be deposited onto the conductive nanopillar array structure 115 (e.g., the conductive nanopillars 125) by way of electron-beam evaporation in one example to create Au/Ag NLNOE arrays such as the NLNOEs 130. A 1-minute wet etching of at least one Ag layer using chromium (Cr) etchant in this example forms plasmonic nanocavities for electrolyte penetration and increases sidewall roughness, exposing plasmonic Au—Ag—Au nanocavity hotspots to a surrounding atmosphere or medium (e.g., electrolyte) for AgCl(s)+e⁻ [symbol] Ag(s)+Cl⁻(aq) redox reactions.

To evaluate the suitability of the NLNOE array device 100 for in situ EC-SERS measurements, optical and electrochemical properties of the NLNOEs 130 were systematically studied in example implementations. In one example, a visible-to-near-infrared (vis-NIR) spectrophotometer was employed for reflectance spectroscopy on a ≈2 cm² NLNOE sample. The reflectance spectra of the NLNOEs 130 in the 400 nm to 1000 nm range from direct measurements and finite-difference time-domain (FDTD) simulations were obtained in one example. The measured reflectance spectrum displayed a broad reflective dip of ~20% from 400 nm to 500 nm due to gold interband transitions and a rebound to ~80% between 500 nm and 700 nm resulting from increased linear backscattering in this example. The FDTD simulations of this example, qualitatively aligning with the measurements, exposed an electric dipole mode at ≈720 nm, corresponding to electric field enhancement at the nanocavity upper rim, observed in near fields |E|². Differences, such as dips at ≈550 nm and ≈720 nm in simulations, can be ascribed to plasmonic mode broadening from fabrication variations.

To corroborate simulation outcomes, SERS spectra from an example NLNOE array device 100 and flat gold samples were compared with surface-modified benzenethiol (BZT) monolayers in one example. An example comparative analysis of averaged spectra of BZT on planar gold and the NLNOE array device 100 was completed using area scans. Flat gold samples lacked discernible BZT peaks, whereas the NLNOE array device 100 significantly enhanced BZT signature peaks due to plasmon enhancement. The SERS EFs of the NLNOE array device 100 was estimated in one example to be ≈10⁶ under 785 nm laser excitation using the formula: SERS EF=(I_{SERS}/N_{SERS})/(I_{Raman}/N_{Raman}), where I_{SERS}, I_{Raman}, N_{SERS}, and N_{Raman} are the BZT SERS intensity, neat BZT Raman intensity for bulk BZT solution, and the numbers of BZT molecules contributing to BZT SERS and neat BZT Raman intensities, respectively.

To examine the electrical and electrochemical properties of the NLNOE array device 100 at the electrode-electrolyte interface, in one example electrochemical impedance spectroscopy (EIS) was conducted on an example NLNOE array device 100 submerged in a 1×Phosphate-Buffered Saline (PBS) solution (pH=7.4), maintained at ambient temperature. The resultant Nyquist plot and the curve fitted via the equivalent circuit of this example were created and the amount of fitting parameters are listed in Table 1 below where the R and C represents resistance and capacitance elements, respectively;

$${Q}_{2} ( f ) = \frac{1}{{{Q}_{2} ( i 2 π f )}^{{a}_{2}}}$$

is the constant phase element (CPE) which reflects the porous nature of the nanocavities as the charges near the electrode do not distribute as ideal electrical double layer (EDL).

$${W}_{2} ( f ) = \sqrt{\frac{{s}_{2}^{2}}{i π f}}$$

is the Warburg impedance, which models semi-infinite linear diffusion. Notably, the coefficient of order (a₂=0.745) of the non-ideal capacitor Q₂ implies the nanostructured interfacial geometric configurations of NLNOEs 130 atop the conductive (e.g., MWCNT/PU) nanopillar array structure 115 on Si substrates.

TABLE 1
Parameters of EIS Z fitting

| | value | unit | deviation |
|---|---|---|---|
| R₁ | 1875 | Ω | 0.4665 |
| Q₂ | 2.43 × 10⁻⁸ | F · s^{(a2-1)} | 8.00 × 10⁻¹² |
| a₂ | 0.7451 | | 0.5 |
| R₂ | 68170 | Ω | 2.692 |
| s₂ | 351367 | Ω · s^{(-1/2)} | 10.1 |
| C₃ | 2.20 × 10⁻⁷ | F | 1.33 × 10⁻¹² |

To confine and control redox reaction at Ag nanogap cavities, cyclic voltammetry was conducted using an example NLNOE array device 100 in one implementation within a potential window of 0.4 V to 0.6 V at a low scan rate of 50 mV/s to induce the AgCl(s)+e⁻ [symbol] Ag(s)+Cl⁻(aq) redox reaction, while the Au layer remained unreactive. Cyclic voltage sweeps result in periodic current modulations in this example, a behavior indicative of the reversible nature of Faradaic and non-Faradaic processes on a stable NLNOE device.

To pinpoint the spectral features more precisely during the redox reaction, 2×6 spectra (e.g., range −50 cm⁻¹ to 500 cm⁻¹) were selected in one example from a single redox cycle (e.g., 100 s to 140 s, the 3^{rd} cycle). The measured spectra unveil three key characteristics: Firstly, the elastic scattering peak at 0 cm⁻¹ remains relatively consistent during the redox reaction; secondly, both the PE-ERS pseudo-peak at ≈87 cm⁻¹ and the PE-VRS peak at ≈258 cm⁻¹ for the Ag—Cl bonds undergo substantial modulation at ±0.2 V during oxidation and reduction, respectively; and thirdly, PE-VRS experiences a more significant increase in peak intensity at 0.2V during oxidation compared to −0.2 V during reduction. The nuanced relationship between electrochemical modulations and alterations in several distinct EC-SERS spectral features was observed in one example. Specifically, an inspection of the interdependencies between electrochemical current I and the normalized emission intensities of PE-VRS, PE-ERS, and elastic scattering signals during voltage modulations from a single (3rd) cycle was completed in this example.

The example measurements described herein reveal several notable observations. Firstly, well-defined Faradaic peaks, marked by an oxidation peak at 0.38 V and a reduction peak at −0.22 V, become visible during voltage sweeps, indicative of the AgCl(s)+e⁻ [symbol] Ag(s)+Cl⁻(aq) redox reaction. The ≈0.6 V redox peak-to-peak distance is considerably larger than that of ordinary Ag/AgCl cyclic voltammetry under similar conditions (≈0.152V), implying that the redox reaction has a quasi-reversible behavior.

A probable explanation for the low electron transfer rate of the reaction is the formation of nanoporous electrolyte networks within Ag/AgCl matrices inside Au—Ag—Au nanocavities of an example NLNOE array device 100 during redox reactions, which limits the mass transport of ions involved in reactions and thereby impedes the reaction rate. Secondly, a PE-VRS peak at ≈258 cm⁻¹ was observed, linked to the stretching vibration of Ag—Cl bonds. The intensity of this peak during voltage modulation exhibits unsynchronized behavior in the Faradaic region for reduction or oxidation, with the PE-VRS peak intensity voltage preceding the Faradaic current peak voltage. Perhaps this PE-VRS peak relates to the (AgCl)*TS, having partial bonding with increased ability for its electron cloud distortion and enhanced polarizability changes compared to the steady-state Ag—Cl bond with a polar covalent nature, resulting in an increased VRS transition dipole moment and amplified PE-VRS signals only during the redox reaction. This observation suggests that the opposing electrical field directions between reduction and oxidation cycles alter the microscopic VRS dipole moment orientation for (AgCl)*relative to the plasmonic electric field, resulting in varying PE-VRS emission intensities.

In the non-Faradaic region, PE-VRS peak intensity increases linearly with voltage due to non-Faradaic capacitive modulation of metal surface charges at hotspots 150, consistent with an earlier study. Thirdly, the PE-ERS pseudo peak at ≈87 cm⁻¹ and tail intensities from 400 to 1400 cm⁻¹ exhibit similar voltage-dependent behavior, indicating a common origin. Additionally, the PE-VRS peak at ≈258 cm⁻¹ and the PE-ERS pseudo peak at ≈87 cm⁻¹ display identical voltage conditions for their peaks, dips, turn-on, and turn-off transitions, revealing a strong link between PE-VRS and PE-ERS events due to the generation of (AgCl)*TS in redox reactions.

Notably, PE-ERS intensity changes are consistent in positive and negative voltage sweeps under Faradaic modulation, suggesting that varying electrical field directions during reduction and oxidation cycles do not impact the ERS dipole moment orientation for (AgCl)*relative to the plasmonic field. Finally, in contrast to redox-modulated PE-VRS and PE-ERS, the inelastic scattering peak at 0 cm⁻¹ shows minor random fluctuations (≈10%), which is possibly due to plasmonic heating causing local refractive index changes from local temperature fluctuation or vapor/gas bubble formation, consequently altering the optical path and efficiency of elastic scattering signal collection.

To elucidate dynamic PE-ERS and PE-VRS behaviors observed in one implementation of an example NLNOE array device 100, a microscopic model was created that captured the evolution of these signals during the electrochemical redox processes. Firstly, the model included microscopic transformations in the Faradaic redox reaction AgCl(s)+e⁻ [symbol] Ag(s)+Cl⁻(aq) at the electrode-electrolyte interface. The potential energy was plotted against the generalized coordinate of Ag—Cl interatomic distance. As the coordinate approached r₀, where energy is minimized, there was a strong coupling between the Ag sp band and Cl p orbitals, forming hybridized Ag—Cl orbitals with a 3.3 eV energy gap, and the steady-state Ag—Cl bond was polar covalent with a small Raman scattering cross-section. At rᵣₛ, where energy peaks, the transition-state (AgCl)*complex formed with diminished coupling between the Ag sp band and Cl orbitals, producing negligible energy gaps between hybridized bonding and antibonding (AgCl)*orbitals, thus contributing extra PE-ERS signals.

This hypothesis of (AgCl)*transition state electronic structure is supported by ab initio calculation work, in which one of the possible transition state configurations is described as a cluster on the interface with a continuous half-filled energy band. Additionally, the (AgCl)*TS's increased ability for electron cloud distortion results in enhanced polarizability changes and elevated VRS transition dipole moment |m*|, compared to the steady-state polar covalent Ag—Cl bond, thereby amplifying PE-VRS signals. This premise, where the (AgCl)*TS features filled bonding and unoccupied antibonding orbitals with negligible energy gaps and increased VRS transition dipole moment, undergirds a subsequent analysis of modulated PE-ERS and PE-ERS signals in the Faradaic process.

A time-dependent, voltage-resolved diagram of measured current, PE-VRS, and PE-ERS intensities from one implementation of an example NLNOE array device 100 was created. A key takeaway from such measured intensities was the discrepancy in peak and turn-on/turn-off voltages (or times) between the electrochemical current and the PE-VRS/PE-ERS emission intensities. Combining this observation with insights from other implementations of example NLNOE array devices 100, it may be inferred that the behaviors of the PE-ERS and PE-VRS signals depend on the location of the emerging (AgCl)*TSs of the redox reaction within the plasmonic nanocavities. The FDTD estimated average PE-ERS and PE-VRS emission EFs, |E_{SP}|⁴/|E₀|⁴, as a function of location (x) across the Ag—AgCl nanoporous network within the top, middle, and bottom Au—Ag—Au nanogap cavities in NLNAs was completed in one implementation of an example NLNOE array device 100. For simulations, a first-order approximation was employed in this example using an ideal cylindrical NLNOE structure (e.g., an example NLNOE array device 100) with a 50 nm radius and random dielectric nanoparticles within Ag layers to model the AgCl—Ag nanoporous network. The results revealed a sharp decline in |E_{SP}|⁴/|E₀|⁴ values as x decreases.

An illustrative diagram was created in one example that comprehensively explains PE-ERS and PE-VRS signal dynamics and highlights the microscopic evolution between the steady-state of covalent Ag—Cl bonds or Ag and Cl elements and the TS of (AgCl)*complex within the nanoporous Ag/AgCl network at six distinct times (t₁ to t₆) during the oxidation and reduction processes using an example NLNOE array device 100. At t₁ and t₄, preceding the onset of oxidation and reduction, respectively, PE-ERS signals were modulated by voltage due to capacitive charging/discharging at the metal surface, whereas PE-VRS signals remained unaffected in the absence of TSs. At t₂ and t₅, the initiation of the AgCl(s)+e⁻ [symbol] Ag(s)+Cl⁻(aq) redox reaction occurred, marked by increased Faradaic current and peak intensities of PE-ERS and PE-VRS. At t₃ and t₆, though the Faradaic current reached its peak, the intensities of PE-ERS and PE-VRS signals then begin to decrease.

Elucidated from the above-described diagram is how the (AgCl)*TS contributes to the emission intensity of the PE-ERS signal. The (AgCl)*TSs typically involve the hybridization between Ag sp bands near the Fermi level and the Cl atomic orbitals, leading to continuous energy states that offer a new trajectory for electron transition-relaxation, thereby enhancing PE-ERS intensity. To systematically analyze contributions from different electron transition pathways to the total PE-ERS intensity, I_{ERS}(δω, r, Δ), the following equation can be implemented in some examples:

$${I}_{E R S} ( δω , r , Δ ) = {I}_{E R S}^{m} ( δω , r ) + {I}_{E R S}^{T S} ( δω , r , Δ ) + {I}_{E R S}^{m T S} ( δω , r , Δ ) = {f}_{S P} ( δω , r ) \{ {Q}_{m} {\int }_{0}^{∞} {g}_{m} ( E ) {f}_{T} ( E ) {g}_{m} ( E + ℏ δ ω ) [ 1 - {f}_{T} ( E ) ] dE + {Q}_{T S} {\int }_{0}^{∞} {g}_{T S}^{Δ} ( E ) {f}_{T} ( E ) {g}_{T S}^{Δ} ( E + ℏ δ ω ) [ 1 - {f}_{T} ( E ) ] dE + {Q}_{T S \to m} {\int }_{0}^{∞} {g}_{T S}^{Δ} ( E ) {f}_{T} ( E ) {g}_{m} ( E + ℏ δ ω ) [ 1 - {f}_{T} ( E ) ] dE + {Q}_{m \to T S} {\int }_{0}^{∞} {g}_{m} ( E ) {f}_{T} ( E ) {g}_{T S}^{Δ} ( E + ℏ δ ω ) [ 1 - {f}_{T} ( E ) ] d E \} \qquad Eq . ( 1 )$$

Equation (1) categorizes PE-ERS processes into three groups based on electron transition pathways. Here, f_{SP}(δω,r)≈|E_{SP}(δω,r)|⁴/|E₀|⁴ represents the PE-ERS EFs at the shifted frequency δω and position r. The term gₘ(E) denotes the electronic density of states for metal (Ag) sp-band at energy E, while

$${g}_{T S}^{Δ} ( E )$$

represents the electronic density of states for hybridized (AgCl)*TSs with an energy bandgap of Δ and centered at energy E. Specifically,

$${I}_{E R S}^{m}$$

describes the PE-ERS process involving transitions solely within the Ag sp band. In contrast,

$${I}_{E R S}^{T S} and {I}_{E R S}^{m - T S}$$

involve ERS excitation-emission transitions mediated by (AgCl)*TSs, with the former accounting for both initial and final states to be TSs, and the latter accounting for one of the initial and final states to be TS. f_{T}(E) represents the Fermi-Dirac distribution, while Q represents each process's corresponding ERS cross-section constant.

Notably,

$${I}_{E R S}^{m}$$

depends on the non-Faradaic capacitive charging and discharging process but not the Faradaic redox process. In contrast,

$${I}_{E R S}^{T S} and {I}_{E R S}^{m - T S}$$

can increase due to the formation of hybridized (AgCl)*TSs with continuous energy levels, providing an additional density of states through the atom's p orbitals. When a steady-state covalent Ag—Cl bond is formed, strong interatomic hybridization induces the bonding and antibonding states with a large energy gap, ceasing the contribution to PE-ERS signals. Therefore, the additional PE-ERS terms,

$${I}_{E R S}^{T S} and {I}_{E R S}^{m - T S} ,$$

only appear when (AgCl)*TSs are formed during the Faradaic redox process.

Next, the focus is on the behavior of PE-VRS during the Faradaic redox process. Similar to PE-ERS, PE-VRS emerges only in the presence of the (AgCl)*TSs because weakly coupled electrons in (AgCl)*TSs have an augmented capacity for electron cloud distortion to enhance polarizability changes and thus VRS transition dipole moment |m*|, compared to the polar covalent Ag—Cl bond in the steady-state. Therefore, PE-VRS follows PE-ERS trends with emerged (AgCl)*TSs during the redox reaction. However, a distinct feature in PE-VRS is the differing amplitude of Faradaic modulation in various reaction directions, which may arise from the (AgCl)*TSs' varying average orientations due to the attractive or repulsive electrostatic forces of positive or negative metal electrode voltages, respectively. The (AgCl)*TSs appear at the boundary of Ag—AgCl porous network channels with different orientations in one example due to the polarity change of induced charges at the metal surface, leading to different alignments of the VRS dipole moment m* with the plasmon-driven electric field E_{SP} in hotspots 150. As a result, the Faradaic modulation amplitude is more pronounced in the reduction direction compared to the oxidation direction.

Next, the manner in which near-field enhancements influence PE-ERS and PE-VRS signals was examined using an example NLNOE array device 100. Plasmonic enhancements for PE-ERS and PE-VRS signals are proportional to |E_{SP}|⁴/|E₀|⁴, which decays exponentially along the nanoporous Ag/AgCl network inward of the Au—Ag—Ag nanocavities of the NLNOE array device 100 in this example. As oxidation/reduction processes proceeded, the positions of redox generated (AgCl)*TSs moved inward. As the reaction progressed, this inward movement resulted in weaker field enhancements on PE-ERS and PE-VRS. Coupled with the emergence of TS in the Faradaic process, the peak intensities of PE-ERS and PE-VRS signals diverged from the current.

Lastly, a brief revisit of the non-Faradaic modulation of PE-ERS and PE-VRS, which has been discussed extensively previously. In the non-Faradaic process, the PE-ERS intensity from metal hotspots 150,

$${I}_{E R S}^{m} ( δω , r ) ,$$

declined linearly with voltage due to the capacitive voltage modulation of the induced charge density on the electrode surface. This surface charge modulation caused a shift in the Fermi energy level on the Ag surface of the NLNOE array device 100 in this example. Since the voltage-modulated surface charge within the Debye length overlapped with the decay length of the plasmonic field, PE-ERS signals showed a high sensitivity to both Faradaic and non-Faradaic voltage modulation processes.

In summary, described herein is a significant advancement for in situ EC-SERS technology, enabling the probing of transition state information during AgCl(s)+e⁻ [symbol] Ag(s)+Cl⁻(aq) redox reactions within plasmonic nanocavities through the integration of PE-ERS and PE-VRS signals. This dual-signal approach provide a nuanced understanding of electronic states at electrode-electrolyte interfaces, expanding EC-SERS applications. The innovative two-tier NLNOE design of the NLNOE array device 100 aligns reaction sites within plasmonic nanogap modes' hotspots, facilitating efficient reaction monitoring through spectral measurements. The adaptability of the design of the NLNOE array device 100 allows for substituting the silver layer with other reactant materials in some cases, supporting the study of a broader range of reactions. While further research in controlling electrochemical interfacial properties and optimizing the nano-optoelectrode design for enhanced signal sensitivity is needed, the example NLNOE array device 100 and methodologies for implementing the same as describe in examples herein are a keystone in elevating the EC-SERS methods for real-time monitoring of various electrochemical and electrocatalytic processes at electrode interfaces.

The reflectance spectra of samples in at least one example were obtained using a UV-vis-near-infrared (NIR) spectrophotometer (Cary 5000), with a wavelength range extending from 400 nm to 1000 nm at intervals of 0.5 nm.

The 3D FDTD simulations were acquired in at least one example using commercial software (e.g., FDTD solutions) to numerically calculate the far-field spectra and the near-field distributions of the plasmonic systems. Optical constants of Au and Ag were taken from Johnson and Christy in the spectrum range from 400 nm to 1000 nm in at least one example. For the refractive index of MWCNT doped PU, a flat sample was fabricated in at least one example with ≈1 μm polymer thickness on glass and performed ellipsometry to obtain the refractive index of MWCNT doped PU as n=1.54+0.05i. To mimic the geometry of the sample according to the SEM and FIB images, the 400 nm×400 nm square lattice was constructed in at least one example with periodic boundary conditions in the x-y plane. For the nanopillar structure, a cone-shaped nanoparticle model and an angled gap surrounding the MWCNT doped PU pillar were formed in one example, and the nanowell was adapted to mimic the shadowing effect in the deposition. The mesh size was 1 nm in the x, y, and z directions in at least one example.

A custom-made EC cell mounted onto a sample was designed in at least one example to contain the liquid and hold the Ag/AgCl reference electrode (saturated in KCl) and platinum coil counter electrode. The electrodes were all connected in at least one example to a commercial potentiostat which provided the potential control and current probe. The electrolyte solution was a phosphate buffer saline (PBS) in at least one example composed of 137 mM NaCl, 2.7 mM KCl, 10 mM Na₂HPO₄, and 1.8 mM KH₂PO₄, with deionized water utilized for dilution. The EC cell was filled with approximately 2 mL of electrolyte solution in at least one example, with all measurements conducted at ambient temperature. Measurements were performed within 10 minutes after introducing the liquid in at least one example to avoid electrolyte purging issues over a prolonged experiment (hours). The substrate was intermittently rinsed with the corresponding concentration of PBS solution in at least one example to ensure its cleanliness and the reliability of the measurements.

Laser excitation at a wavelength of 785 nm and power of 2 mW was used in at least one example for the Raman measurements, focused with a 10×objective (NA=0.25) lens in a commercial confocal microscope in the backscattering configuration. Single-point measurements were done in at least one example at a 0.5 s integration time and captured by a CCD camera in a commercial spectrometer to measure the Stokes-Raman scattering. A long-pass filter was used in at least one example to block elastically scattered light at the wavelength corresponding to the laser line (Rayleigh scattering), with the Stokes scattering transmitted through a multimode fiber (e.g., 100 micrometer (μm) core diameter) wherein the cleaved fiber core functioned as the confocal pinhole. EC modulation was performed in at least one example using a custom EC cell and commercial potentiostat, with the NLNOEs serving as the working electrode, a platinum coil as the counter electrode, and Ag/AgCl as the reference electrode, as previously described.

Disjunctive language, such as the phrase “at least one of X, Y, or Z,” unless specifically stated otherwise, is to be understood with the context as used in general to present that an item, term, or the like, can be either X, Y, or Z, or any combination thereof (e.g., X, Y, and/or Z). Thus, such disjunctive language is not generally intended to, and should not, imply that certain embodiments require at least one of X, at least one of Y, or at least one of Z to be each present. As referenced herein in the context of quantity, the terms “a” or “an” are intended to mean “at least one” and are not intended to imply “one and only one.”

As referred to herein, the terms “include,” “includes,” and “including” are intended to be inclusive in a manner similar to the term “comprising.” As referenced herein, the terms “or” and “and/or” are generally intended to be inclusive, that is (i.e.), “A or B” or “A and/or B” are each intended to mean “A or B or both.” As referred to herein, the terms “first,” “second,” “third,” and so on, can be used interchangeably to distinguish one component or entity from another and are not intended to signify location, functionality, or importance of the individual components or entities. As referenced herein, the terms “couple,” “couples,” “coupled,” and/or “coupling” refer to chemical coupling (e.g., chemical bonding), communicative coupling, electrical and/or electromagnetic coupling (e.g., capacitive coupling, inductive coupling, direct and/or connected coupling), mechanical coupling, operative coupling, optical coupling, and/or physical coupling.

It should be emphasized that the above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

Therefore, at least the following is claimed:

1. A nano-optoelectrode device, comprising:
a substrate;
a conductive layer coupled to the substrate; and
a nano-optoelectrode coupled to the conductive layer, the nano-optoelectrode comprising:
a conductive nanopillar extending from the conductive layer;
a nanostructure coupled to the conductive nanopillar, the nanostructure comprising alternating layers of reactive metal and stable plasmonic metal; and
a plasmonic nanocavity hotspot on a side of the nanostructure, the plasmonic nanocavity hotspot comprising side surfaces of the alternating layers of reactive metal and stable plasmonic metal of the nanostructure.

2. The nano-optoelectrode device of claim 1, wherein the substrate comprises a polyethylene terephthalate substrate.

3. The nano-optoelectrode device of claim 1, wherein at least one of the conductive layer or the conductive nanopillar comprises a multiwall carbon nanotube doped polyurethane compound.

4. The nano-optoelectrode device of claim 1, wherein the nanostructure further comprises at least one of a nanoantenna, an optical nanoantenna, or a nanocavity.

5. The nano-optoelectrode device of claim 1, wherein the nanostructure is coupled to a distal end of the conductive nanopillar.

6. The nano-optoelectrode device of claim 1, wherein a reactive metal layer of the alternating layers of reactive metal and stable plasmonic metal comprises a silver layer.

7. The nano-optoelectrode device of claim 1, wherein a reactive metal layer of the alternating layers of reactive metal and stable plasmonic metal comprises a rare earth metal layer.

8. The nano-optoelectrode device of claim 1, wherein a reactive metal layer of the alternating layers of reactive metal and stable plasmonic metal comprises at least one of a scandium (Sc) layer, a yttrium (Y) layer, a lanthanum (La) layer, a cerium (Ce) layer, a praseodymium (Pr) layer, a neodymium (Nd) layer, a promethium (Pm) layer, a samarium (Sm) layer, a europium (Eu) layer, a gadolinium (Gd) layer, a terbium (Tb) layer, a dysprosium (Dy) layer, a holmium (Ho) layer, an erbium (Er) layer, a thulium (Tm) layer, a ytterbium (Yb) layer, or a lutetium (Lu) layer.

9. The nano-optoelectrode device of claim 1, wherein a stable plasmonic metal layer of the alternating layers of reactive metal and stable plasmonic metal comprises a gold layer.

10. The nano-optoelectrode device of claim 1, wherein a stable plasmonic metal layer of the alternating layers of reactive metal and stable plasmonic metal comprises a titanium nitride (TiN) layer.

11. The nano-optoelectrode device of claim 1, wherein different portions of the alternating layers of reactive metal and stable plasmonic metal are respectively formed on a distal end of the conductive nanopillar and a top surface of the conductive layer.

12. The nano-optoelectrode device of claim 1, wherein the alternating layers of reactive metal and stable plasmonic metal comprise alternating nanoscale layers of silver and gold formed on a distal end of the conductive nanopillar.

13. The nano-optoelectrode device of claim 1, wherein the alternating layers of reactive metal and stable plasmonic metal comprise at least one reactive metal layer and at least two stable plasmonic metal layers.

14. The nano-optoelectrode device of claim 1, wherein the alternating layers of reactive metal and stable plasmonic metal comprise:
a first stable plasmonic metal layer formed on a distal end of the conductive nanopillar;
a first reactive metal layer formed on the first stable plasmonic metal layer;
a second stable plasmonic metal layer formed on the first reactive metal layer;
a second reactive metal layer formed on the second stable plasmonic metal layer;
a third stable plasmonic metal layer formed on the second reactive metal layer;
a third reactive metal layer formed on the third stable plasmonic metal layer;
a fourth stable plasmonic metal layer formed on the third reactive metal layer.

15. The nano-optoelectrode device of claim 1, wherein at least one stable plasmonic metal layer of the alternating layers of reactive metal and stable plasmonic metal has a thickness ranging between 20 nanometers to 25 nanometers.

16. The nano-optoelectrode device of claim 1, wherein at least one reactive metal layer of the alternating layers of reactive metal and stable plasmonic metal has a thickness ranging between 5 nanometers to 10 nanometers.

17. The nano-optoelectrode device of claim 1, wherein at least one reactive metal layer of the alternating layers of reactive metal and stable plasmonic metal has a thickness ranging between 7.5 nanometers to 12.5 nanometers.

18. The nano-optoelectrode device of claim 1, wherein at least one reactive metal layer of the alternating layers of reactive metal and stable plasmonic metal has a thickness ranging between 10 nanometers to 15 nanometers.

19. The nano-optoelectrode device of claim 1, wherein the alternating layers of reactive metal and stable plasmonic metal comprise:
a first reactive metal layer having a thickness of 8 nanometers;
a second reactive metal layer having a thickness of 10 nanometers; and
a third reactive metal layer having a thickness of 12 nanometers.

20. The nano-optoelectrode device of claim 19, wherein:
the first reactive metal layer is formed at a first distance from a surface of the conductive layer;
the second reactive metal layer is formed at a second distance from the surface of the conductive layer that is greater than the first distance; and
the third reactive metal layer is formed at a third distance from the surface of the conductive layer that is greater than the second distance.

21. The nano-optoelectrode device of claim 1, wherein the nanostructure further comprises plasmonic nanocavities in at least one reactive metal layer of the alternating layers of reactive metal and stable plasmonic metal.

22. The nano-optoelectrode device of claim 1, wherein the nano-optoelectrode device comprises a nano-optoelectrode probe device for probing transition states of redox reactions.

23. The nano-optoelectrode device of claim 1, wherein the nano-optoelectrode device comprises a nano-optoelectrode probe device for in situ electrochemical surface-enhanced Raman spectroscopy measurements.

24. The nano-optoelectrode device of claim 1, wherein the nano-optoelectrode device comprises a nano-optoelectrode probe device for capturing vibrational and electronic signatures of silver-chlorine transition states in a redox reaction based at least in part on plasmon-enhanced vibrational Raman scattering and plasmon-enhanced electronic Raman scattering, respectively.

25. A nano-optoelectrode system, comprising:
a potentiostat;
a continuous wave laser; and
a nano-optoelectrode device coupled to the potentiostat and the continuous wave laser, the nano-optoelectrode device comprising:
a substrate;
a conductive layer coupled to the substrate; and
a nano-optoelectrode coupled to the conductive layer, the nano-optoelectrode comprising:
a conductive nanopillar extending from the conductive layer;
a nanostructure coupled to the conductive nanopillar, the nanostructure comprising alternating layers of reactive metal and stable plasmonic metal; and
a plasmonic nanocavity hotspot on a side of the nanostructure, the plasmonic nanocavity hotspot comprising side surfaces of the alternating layers of reactive metal and stable plasmonic metal of the nanostructure.

26. The nano-optoelectrode system of claim 25, wherein the conductive layer and the conductive nanopillar are coupled to the potentiostat by way of a copper wire.

27. The nano-optoelectrode system of claim 26, wherein the conductive layer and the conductive nanopillar collectively form a working electrode.

28. The nano-optoelectrode system of claim 25, wherein the nano-optoelectrode device is coupled to the potentiostat by way of a platinum wire.

29. The nano-optoelectrode system of claim 28, wherein the platinum wire comprises a counter electrode.

30. The nano-optoelectrode system of claim 25, wherein the nanostructure is coupled to the potentiostat.

31. The nano-optoelectrode system of claim 30, wherein the nanostructure comprises a reference electrode.
